(19) United States
(12) Patent Application Publication
(10) Pub. No.: US 2008/0294372 A1
(43) Pub. Date: Nov. 27, 2008

(54) PROJECTION FACILITY WITHIN AN ANALYTIC PLATFORM

(76) Inventors: Herbert Dennis Hunt, San Francisco, CA (US); John Randall West, Sunnyvale, CA (US); Marshall Ashby Gibbs, Clarendon Hills, IL (US); Bradley Michael Griglione, Lake Zurich, IL (US); Gregory David Neil Hudson, Riverside, IL (US); Andrea Basilico, Manera di Lomazzo (Como) (IT); Arvid C. Johnson, Frankfort, IL (US); Cheryl G. Bergeon, Arlington Heights, IL (US); Craig Joseph Chapa, Lake Barrington, IL (US); Alberto Agostinelli, Trezzo sull'Adda (Milano) (IT); Jay Alan Yusko, Lombard, IL (US); Trevor Mason, Bolingbrook, IL (US)

Correspondence Address: STRATEGIC PATENTS P.C.., C/O PORTFOLIOIP, P.O. BOX 52050, MINNEAPOLIS, MN, 55402, US

(21) Appl. No.: 12/023,294

(22) Filed: Jan. 31, 2008

Related U.S. Application Data
(63) Continuation-in-part of application No. 12/021,263, filed on Jan. 28, 2008.
(60) Provisional application No. 60/886,798, filed on Jan. 26, 2007.
(60) Provisional application No. 60/886,801, filed on Jan. 26, 2007.
(60) Provisional application No. 60/887,573, filed on Jan. 31, 2007.
(60) Provisional application No. 60/891,508, filed on Feb. 24, 2007.
(60) Provisional application No. 60/891,936, filed on Feb. 27, 2007.
(60) Provisional application No. 60/952,898, filed on Jul. 31, 2007.

(51) Int. Cl. G06F 17/18

(52) U.S. Cl. 702/179

(57) ABSTRACT

In embodiments of the present invention improved capabilities are described for using an analytic platform to obtain a projection. A core information matrix may be developed for data set, where the core information matrix may include regions representing the statistical characteristics of alternative projection techniques that may be applied to the data set. In addition, a user may be provided with an interface whereby the user may observe the regions of the core information matrix to facilitate selecting an appropriate projection technique.

### CROSS-REFERENCE TO RELATED APPLICATIONS

This application claims the benefit of the following U.S. provisional applications: App. No. 60/887,573 filed on Jan. 31, 2007 and entitled “Analytic Platform,” App. No. 60/891,508 filed on Feb. 24, 2007 and entitled “Analytic Platform,” App. No. 60/891,936 filed on Feb. 27, 2007 and entitled “Analytic Platform,” App. No. 60/952,898 filed on Jul. 31, 2007 and entitled “Analytic Platform.”

This application is a continuation-in-part of U.S. application Ser. No. 12/021,263 filed on Jan. 28, 2008 and entitled “Associating a Granting Matrix with an Analytic Platform”, which claims the benefit of the following U.S. provisional applications: App. No. 60/886,798 filed on Jan. 26, 2007 and entitled “A Method of Aggregating Data,” App. No. 60/886,801 filed on Jan. 26, 2007 and entitled “Utilizing Aggregated Data.”

Each of the above applications is incorporated by reference herein in its entirety.

### BACKGROUND

1. Field

This invention relates to methods and systems for analyzing data, and more particularly to methods and systems for aggregating, projecting, and releasing data.

2. Description of Related Art

Currently, there exists a large variety of data sources, such as census data or movement data received from point-of-sale terminals, sample data received from manual surveys, panel data obtained from the inputs of consumers who are members of panels, fact data relating to products, sales, and many other facts associated with the sales and marketing efforts of an enterprise, and dimension data relating to dimensions along which an enterprise wishes to understand data, such as in order to analyze consumer behaviors, to predict likely outcomes of decisions relating to an enterprise's activities, and to project from sample sets of data to a larger universe. Conventional methods of synthesizing, aggregating, and exploring such a universe of data comprise techniques such as OLAP, which fix aggregation points along the dimensions of the universe in order to reduce the size and complexity of unified information sets such as OLAP stars. Exploration of the unified information sets can involve run-time queries and query-time projections, both of which are constrained in current methods by a priori decisions that must be made to project and aggregate the universe of data. In practice, going back and changing the a priori decisions can lift these constraints, but this requires an arduous and computationally complex restructuring and reprocessing of data.

According to current business practices, unified information sets and results drawn from such information sets can be released to third parties according to so-called “releasability” rules. Theses rules might apply to any and all of the data from which the unified information sets are drawn, the dimensions (or points or ranges along the dimensions), the third party (or members or sub-organizations of the third party), and so on. Given this, there can be a complex interaction between the data, the dimensions, the third party, the releasability rules, the levels along the dimensions at which aggregations are performed, the information that is drawn from the unified information sets, and so on. In practice, configuring a system to apply the releasability rules is an error-prone process that requires extensive manual set up and results in a brittle mechanism that cannot adapt to on-the-fly changes in data, dimensions, third parties, rules, aggregations, projections, user queries, and so on.

Various projection methodologies are known in the art. Still other projection methodologies are subjects of the present invention. In any case, different projection methodologies provide outputs that have different statistical qualities. Analysts are interested in specifying the statistical qualities of the outputs at query-time. In practice, however, the universe of data and the projection methodologies that are applied to it are what drive the statistical qualities. Existing methods allow an analyst to choose a projection methodology and thereby affect the statistical qualities of the output, but this does not satisfy the analyst's desire to directly dictate the statistical qualities.

Information systems are a significant bottle neck for market analysis activities. The architecture of information systems is often not designed to provide on-demand flexible access, integration at a very granular level, or many other critical capabilities necessary to support growth. Thus, information systems are counter-productive to growth. Hundreds of market and consumer databases make it very difficult to manage or integrate data. For example, there may be a separate database for each data source, hierarchy, and other data characteristics relevant to market analysis. Different market views and product hierarchies proliferate among manufacturers and retailers. Restatements of data hierarchies waste precious time and are very expensive. Navigation from among views of data, such as from global views to regional to neighborhood to store views is virtually impossible, because there are different hierarchies used to store data from global to region to neighborhood to store-level data. Analyses and insights often take weeks or months, or they are never produced. Insights are often sub-optimal because of silo-driven, narrowly defined, ad hoc analysis projects. Reflecting the ad hoc nature of these analytic projects are the analytic tools and infrastructure developed to support them. Currently, market analysis, business intelligence, and the like often use rigid data cubes that may include hundreds of databases that are impossible to integrate. These systems may include hundreds of views, hierarchies, clusters, and so forth, each of which is associated with its own rigid data cube. This may make it almost impossible to navigate from global uses that are used, for example, to develop overall company strategy, down to specific program implementation or customer-driven uses. These ad hoc analytic tools and infrastructure are fragmented and disconnected.

In sum, there are many problems associated with the data used for market analysis, and there is a need for a flexible, extendable analytic platform, the architecture for which is designed to support a broad array of evolving market analysis needs. Furthermore, there is a need for better business intelligence in order to accelerate revenue growth, make business intelligence more customer-driven, to gain insights about markets in a more timely fashion, and a need for data projection and release methods and systems that provide improved dimensional flexibility, reduced query-time computational complexity, automatic selection and blending of projection methodologies, and flexibly applied releasability rules.

### SUMMARY

In embodiments, systems and methods may involve using a platform as disclosed herein for applications described herein where the systems and methods involve taking a dataset from which is desired to obtain a projection. A core information matrix may be developed for data set, where the core information matrix may include regions representing the statistical characteristics of alternative projection techniques that may be applied to the data set. In addition, a user may be provided with an interface whereby the user may observe the regions of the core information matrix to facilitate selecting an appropriate projection technique.

In embodiments, the statistical characteristics may include goodness of fit, a co-linearity between independent variables used in the data projection, model stability, validity, a standard error of an independent variable, a residual, a user-specified criterion, accuracy, flexibility, consistency, a measure of spillage, a calibration, a similarity statistic, a quality measure, and the like.

These and other systems, methods, objects, features, and advantages of the present invention will be apparent to those skilled in the art from the following detailed description of the preferred embodiment and the drawings. Capitalized terms used herein (such as relating to titles of data objects, tables, or the like) should be understood to encompass other similar content or features performing similar functions, except where the context specifically limits such terms to the use herein.

### BRIEF DESCRIPTION OF THE FIGURES

The invention and the following detailed description of certain embodiments thereof may be understood by reference to the following figures:

FIG. 1 illustrates an analytic platform for performing data analysis.

FIG. 2 illustrates various projection methodologies in relation to the projection facility.

FIG. 3 illustrates Boolean logic and information logic.

FIG. 4 illustrates a core information matrix.

FIG. 5 illustrates types of projections in relation to the core information matrix.

FIG. 6 illustrates projection types in relation to geographies.

FIG. 7 illustrates projection types in relation to geographies.

FIG. 8 illustrates projection types in relation to geographies.

FIG. 9 illustrates a logical view of geography types that are supported by the projection facility.

FIG. 10 is a logical flow diagram of a set-up process or step.

FIG. 11 is a logical flow diagram of an initialization process or step.

FIG. 12 is a logical flow diagram of a projection computation process or step.

FIG. 13 depicts a logical flow of a projection process.

### DETAILED DESCRIPTION

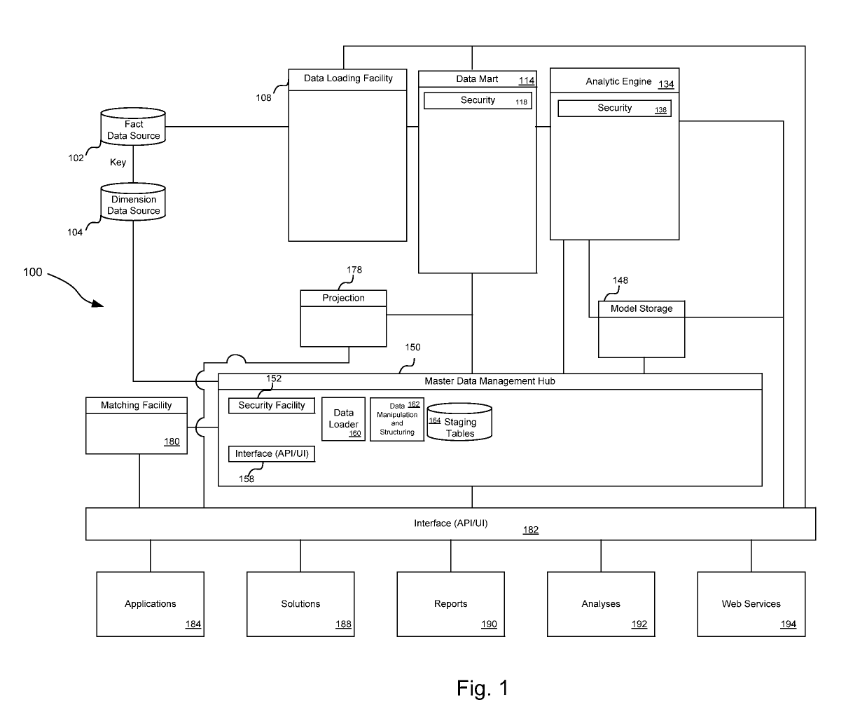

Referring to FIG. 1, the methods and systems disclosed herein are related to improved methods for handling and using data and metadata for the benefit of an enterprise. An analytic platform 100 may support and include such improved methods and systems. The analytic platform 100 may include, in certain embodiments, a range of hardware systems, software modules, data storage facilities, application programming interfaces, human-readable interfaces, and methodologies, as well as a range of applications, solutions, products, and methods that use various outputs of the analytic platform 100, as more particularly detailed herein, other embodiments of which would be understood by one of ordinary skill in the art and are encompassed herein. Among other components, the analytic platform 100 includes methods and systems for providing various representations of data and metadata, methodologies for acting on data and metadata, an analytic engine, and a data management facility that is capable of handling disaggregated data and performing aggregation, calculations, functions, and real-time or quasi-real-time projections. In certain embodiments, the methods and systems enable much more rapid and flexible manipulation of data sets, so that certain calculations and projections can be done in a fraction of the time as compared with older generation systems.

In embodiments, data compression and aggregations of data, such as fact data sources 102, and dimension data sources 104, may be performed in conjunction with a user query such that the aggregation dataset can be specifically generated in a form most applicable for generating calculations and projections based on the query. In embodiments, data compression and aggregations of data may be done prior to, in anticipation of, and/or following a query. In embodiments, an analytic platform 100 (described in more detail below) may calculate projections and other solutions dynamically and create hierarchical data structures with custom dimensions that facilitate the analysis. Such methods and systems may be used to process point-of-sale (POS) data, retail information, geography information, causal information, survey information, census data and other forms of data and forms of assessments of past performance (e.g. estimating the past sales of a certain product within a certain geographical region over a certain period of time) or projections of future results (e.g. estimating the future or expected sales of a certain product within a certain geographical region over a certain period of time). In turn, various estimates and projections can be used for various purposes of an enterprise, such as relating to purchasing, supply chain management, handling of inventory, pricing decisions, the planning of promotions, marketing plans, financial reporting, and many others.

Referring still to FIG. 1 an analytic platform 100 is illustrated that may be used to analyze and process data in a disaggregated or aggregated format, including, without limitation, dimension data defining the dimensions along which various items are measured and factual data about the facts that are measured with respect to the dimensions. Factual data may come from a wide variety of sources and be of a wide range of types, such as traditional periodic point-of-sale (POS) data, causal data (such as data about activities of an enterprise, such as in-store promotions, that are posited to cause changes in factual data), household panel data, frequent shopper program information, daily, weekly, or real time POS data, store database data, store list files, stubs, dictionary data, product lists, as well as custom and traditional audit data. Further extensions into transaction level data, RFID data and data from non-retail industries may also be processed according to the methods and systems described herein.

In embodiments, a data loading facility 108 may be used to extract data from available data sources and load them to or within the analytic platform 100 for further storage, manipulation, structuring, fusion, analysis, retrieval, querying and other uses. The data loading facility 108 may have the a plurality of responsibilities that may include eliminating data for non-releasable items, providing correct venue group flags for a venue group, feeding a core information matrix with relevant information (such as and without limitation statistical metrics), or the like. In an embodiment, the data loading facility 108 eliminate non-related items. Available data sources may include a plurality of fact data sources 102 and a plurality of dimension data sources 104. Fact data sources 102 may include, for example, facts about sales volume, dollar sales, distribution, price, POS data, loyalty card transaction files, sales audit files, retailer sales data, and many other fact data sources 102 containing facts about the sales of the enterprise, as well as causal facts, such as facts about activities of the enterprise, in-store promotion audits, electronic pricing and/or promotion files, feature ad coding files, or others that tend to influence or cause changes in sales or other events, such as facts about in-store promotions, advertising, incentive programs, and the like. Other fact data sources may include custom shelf audit files, shipment data files, media data files, explanatory data (e.g., data regarding weather), attitudinal data, or usage data. Dimension data sources 104 may include information relating to any dimensions along which an enterprise wishes to collect data, such as dimensions relating to products sold (e.g. attribute data relating to the types of products that are sold, such as data about UPC codes, product hierarchies, categories, brands, sub-brands, SKUs and the like), venue data (e.g. store, chain, region, country, etc.), time data (e.g. day, week, quad-week, quarter, 12-week, etc.), geographic data (including breakdowns of stores by city, state, region, country or other geographic groupings), consumer or customer data (e.g. household, individual, demographics, household groupings, etc.), and other dimension data sources 104. While embodiments disclosed herein relate primarily to the collection of sales and marketing-related facts and the handling of dimensions related to the sales and marketing activities of an enterprise, it should be understood that the methods and systems disclosed herein may be applied to facts of other types and to the handling of dimensions of other types, such as facts and dimensions related to manufacturing activities, financial activities, information technology activities, media activities, supply chain management activities, accounting activities, political activities, contracting activities, and many others.

In an embodiment, the analytic platform 100 comprises a combination of data, technologies, methods, and delivery mechanisms brought together by an analytic engine. The analytic platform 100 may provide a novel approach to managing and integrating market and enterprise information and enabling predictive analytics. The analytic platform 100 may leverage approaches to representing and storing the base data so that it may be consumed and delivered in real-time, with flexibility and open integration. This representation of the data, when combined with the analytic methods and techniques, and a delivery infrastructure, may minimize the processing time and cost and maximize the performance and value for the end user. This technique may be applied to problems where there may be a need to access integrated views across multiple data sources, where there may be a large multi-dimensional data repository against which there may be a need to rapidly and accurately handle dynamic dimensionality requests, with appropriate aggregations and projections, where there may be highly personalized and flexible real-time reporting 190, analysis 192 and forecasting capabilities required, where there may be a need to tie seamlessly and on-the-fly with other enterprise applications 184 via web services 194 such as to receive a request with specific dimensionality, apply appropriate calculation methods, perform and deliver an outcome (e.g. dataset, coefficient, etc.), and the like.

The analytic platform 100 may provide innovative solutions to application partners, including on-demand pricing insights, emerging category insights, product launch management, loyalty insights, daily data out-of-stock insights, assortment planning, on-demand audit groups, neighborhood insights, shopper insights, health and wellness insights, consumer tracking and targeting, and the like.

A decision framework may enable new revenue and competitive advantages to application partners by brand building, product innovation, consumer-centric retail execution, consumer and shopper relationship management, and the like. Predictive planning and optimization solutions, automated analytics and insight solutions, and on-demand business performance reporting may be drawn from a plurality of sources, such as InfoScan, total C-scan, daily data, panel data, retailer direct data, SAP, consumer segmentation, consumer demographics, FSP/loyalty data, data provided directly for customers, or the like.

The analytic platform 100 may have advantages over more traditional federation/consolidation approaches, requiring fewer updates in a smaller portion of the process. The analytic platform 100 may support greater insight to users, and provide users with more innovative applications. The analytic platform 100 may provide a unified reporting and solutions framework, providing on-demand and scheduled reports in a user dashboard with summary views and graphical dial indicators, as well as flexible formatting options. Benefits and products of the analytic platform 100 may include non-additive measures for custom product groupings, elimination of restatements to save significant time and effort, cross-category visibility to spot emerging trends, provide a total market picture for faster competitor analysis, provide granular data on demand to view detailed retail performance, provide attribute driven analysis for market insights, and the like.

The analytic capabilities of the present invention may provide for on-demand projection, on-demand aggregation, multi-source master data management, and the like. On-demand projection may be derived directly for all possible geographies, store and demographic attributes, per geography or category, with built-in dynamic releasability controls, and the like. On-demand aggregation may provide both additive and non-additive measures, provide custom groups, provide cross-category or geography analytics, and the like. Multi-source master data management may provide management of dimension member catalogue and hierarchy attributes, processing of raw fact data that may reduce harmonization work to attribute matching, product and store attributes stored relationally, with data that may be extended independently of fact data, and used to create additional dimensions, and the like.

In addition, the analytic platform 100 may provide flexibility, while maintaining a structured user approach. Flexibility may be realized with multiple hierarchies applied to the same database, the ability to create new custom hierarchies and views, rapid addition of new measures and dimensions, and the like. The user may be provided a structured approach through publishing and subscribing reports to a broader user base, by enabling multiple user classes with different privileges, providing security access, and the like. The user may also be provided with increased performance and ease of use, through leading-edge hardware and software, and web application for integrated analysis.

In embodiments, the data available within a fact data source 102 and a dimension data source 104 may be linked, such as through the use of a key. For example, key-based fusion of fact 102 and dimension data 104 may occur by using a key, such as using the Abilitec Key software product offered by Acxiom, in order to fuse multiple sources of data. For example, such a key can be used to relate loyalty card data (e.g., Grocery Store 1 loyalty card, Grocery Store 2 loyalty card, and Convenience Store 1 loyalty card) that are available for a single customer, so that the fact data from multiple sources can be used as a fused data source for analysis on desirable dimensions. For example, an analyst might wish to view time-series trends in the dollar sales allotted by the customer to each store within a given product category.

In embodiments the data loading facility may comprise any of a wide range of data loading facilities, including or using suitable connectors, bridges, adaptors, extraction engines, transformation engines, loading engines, data filtering facilities, data cleansing facilities, data integration facilities, or the like, of the type known to those of ordinary skill in the art. In various embodiments, there are many situations where a store will provide POS data and causal information relating to its store. For example, the POS data may be automatically transmitted to the facts database after the sales information has been collected at the stores POS terminals. The same store may also provide information about how it promoted certain products, its store or the like. This data may be stored in another database; however, this causal information may provide one with insight on recent sales activities so it may be used in later sales assessments or forecasts. Similarly, a manufacturer may load product attribute data into yet another database and this data may also be accessible for sales assessment or projection analysis. For example, when making such analysis one may be interested in knowing what categories of products sold well or what brand sold well. In this case, the causal store information may be aggregated with the POS data and dimension data corresponding to the products referred to in the POS data. With this aggregation of information one can make an analysis on any of the related data.

Referring still to FIG. 1, data that is obtained by the data loading facility 108 may be transferred to a plurality of facilities within the analytic platform 100, including the data mart 114. In embodiments the data loading facility 108 may contain one or more interfaces 182 by which the data loaded by the data loading facility 108 may interact with or be used by other facilities within the platform 100 or external to the platform. Interfaces to the data loading facility 108 may include human-readable user interfaces, application programming interfaces (APIs), registries or similar facilities suitable for providing interfaces to services in a services oriented architecture, connectors, bridges, adaptors, bindings, protocols, message brokers, extraction facilities, transformation facilities, loading facilities and other data integration facilities suitable for allowing various other entities to interact with the data loading facility 108. The interfaces 182 may support interactions with the data loading facility 108 by applications 184, solutions 188, reporting facilities 190, analyses facilities 192, services 194 or other entities, external to or internal to an enterprise. In embodiments these interfaces are associated with interfaces 182 to the platform 100, but in other embodiments direct interfaces may exist to the data loading facility 108, either by other components of the platform 100, or by external entities.

Referring still to FIG. 1, in embodiments the data mart facility 114 may be used to store data loaded from the data loading facility 108 and to make the data loaded from the data loading facility 108 available to various other entities in or external to the platform 100 in a convenient format. Within the data mart 114 facilities may be present to further store, manipulate, structure, subset, merge, join, fuse, or perform a wide range of data structuring and manipulation activities. The data mart facility 114 may also allow storage, manipulation and retrieval of metadata, and perform activities on metadata similar to those disclosed with respect to data. Thus, the data mart facility 114 may allow storage of data and metadata about facts (including sales facts, causal facts, and the like) and dimension data, as well as other relevant data and metadata. In embodiments, the data mart facility 114 may compress the data and/or create summaries in order to facilitate faster processing by other of the applications 184 within the platform 100 (e.g. the analytic server 134). In embodiments the data mart facility 114 may include various methods, components, modules, systems, sub-systems, features or facilities associated with data and metadata.

In certain embodiments the data mart facility 114 may contain one or more interfaces 182 (not shown on FIG. 1), by which the data loaded by the data mart facility 114 may interact with or be used by other facilities within the platform 100 or external to the platform. Interfaces to the data mart facility 114 may include human-readable user interfaces, application programming interfaces (APIs), registries or similar facilities suitable for providing interfaces to services in a services oriented architecture, connectors, bridges, adaptors, bindings, protocols, message brokers, extraction facilities, transformation facilities, loading facilities and other data integration facilities suitable for allowing various other entities to interact with the data mart facility 114. These interfaces may comprise interfaces 182 to the platform 100 as a whole, or may be interfaces associated directly with the data mart facility 114 itself, such as for access from other components of the platform 100 or for access by external entities directly to the data mart facility 114. The interfaces 182 may support interactions with the data mart facility 114 by applications 184, solutions 188, reporting facilities 190, analyses facilities 192, services 194 (each of which is describe in greater detail herein) or other entities, external to or internal to an enterprise.

In certain optional embodiments, the security facility 118 may be any hardware or software implementation, process, procedure, or protocol that may be used to block, limit, filter or alter access to the data mart facility 114, and/or any of the facilities within the data mart facility 114, by a human operator, a group of operators, an organization, software program, bot, virus, or some other entity or program. The security facility 118 may include a firewall, an anti-virus facility, a facility for managing permission to store, manipulate and/or retrieve data or metadata, a conditional access facility, a logging facility, a tracking facility, a reporting facility, an asset management facility, an intrusion-detection facility, an intrusion-prevention facility or other suitable security facility.

Still referring to FIG. 1, the analytic platform 100 may include an analytic engine 134. The analytic engine 134 may be used to build and deploy analytic applications or solutions or undertake analytic methods based upon the use of a plurality of data sources and data types. Among other things, the analytic engine 134 may perform a wide range of calculations and data manipulation steps necessary to apply models, such as mathematical and economic models, to sets of data, including fact data, dimension data, and metadata. The analytic engine 134 may be associated with an interface 182, such as any of the interfaces described herein.

The analytic engine 134 may interact with a model storage facility 148, which may be any facility for generating models used in the analysis of sets of data, such as economic models, econometric models, forecasting models, decision support models, estimation models, projection models, and many others. In embodiments output from the analytic engine 134 may be used to condition or refine models in the model storage 148; thus, there may be a feedback loop between the two, where calculations in the analytic engine 134 are used to refine models managed by the model storage facility 148.

In embodiments, a security facility 138 of the analytic engine 134 may be the same or similar to the security facility 118 associated with the data mart facility 114, as described herein. Alternatively, the security facility 138 associated with the analytic engine 134 may have features and rules that are specifically designed to operate within the analytic engine 134.

As illustrated in FIG. 1, the analytic platform 100 may contain a master data management hub 150 (MDMH). In embodiments the MDMH 150 may serve as a central facility for handling dimension data used within the analytic platform 100, such as data about products, stores, venues, geographies, time periods and the like, as well as various other dimensions relating to or associated with the data and metadata types in the data sources 102, 104, the data loading facility 108, the data mart facility 114, the analytic engine 134, the model storage facility 148 or various applications, 184, solutions 188, reporting facilities 190, analytic facilities 192 or services 194 that interact with the analytic platform 100. The MDMH 150 may in embodiments include a security facility 152, an interface 158, a data loader 160, a data manipulation and structuring facility 162, and one or more staging tables 164. The data loader 160 may be used to receive data. Data may enter the MDMH from various sources, such as from the data mart 114 after the data mart 114 completes its intended processing of the information and data that it received as described herein. Data may also enter the MDMH 150 through a user interface 158, such as an API or a human user interface, web browser or some other interface, of any of the types disclosed herein or in the documents incorporated by reference herein. The user interface 158 may be deployed on a client device, such as a PDA, personal computer, laptop computer, cellular phone, or some other client device capable of handling data. In embodiments, the staging tables 164 may be included in the MDMH 150.

In embodiments, a matching facility 180 may be associated with the MDMH 150. The matching facility 180 may receive an input data hierarchy within the MDMH 150 and analyze the characteristics of the hierarchy and select a set of attributes that are salient to a particular analytic interest (e.g., product selection by a type of consumer, product sales by a type of venue, and so forth). The matching facility 180 may select primary attributes, match attributes, associate attributes, block attributes and prioritize the attributes. The matching facility 180 may associate each attribute with a weight and define a set of probabilistic weights. The probabilistic weights may be the probability of a match or a non-match, or thresholds of a match or non-match that is associated with an analytic purpose (e.g., product purchase). The probabilistic weights may then be used in an algorithm that is run within a probabilistic matching engine (e.g., IBM QualityStage). The output of the matching engine may provide information on, for example, other products which are appropriate to include in a data hierarchy, the untapped market (i.e. other venues) in which a product is probabilistically more likely to sell well, and so forth. In embodiments, the matching facility 180 may be used to generate projections of what types of products, people, customers, retailers, stores, store departments, etc. are similar in nature and therefore they may be appropriate to combine in a projection or an assessment.

As illustrated in FIG. 1, the analytic platform 100 may include a projection facility 178. A projection facility 178 may be used to produce projections, whereby a partial data set (such as data from a subset of stores of a chain) is projected to a universe (such as all of the stores in a chain), by applying appropriate weights to the data in the partial data set. A wide range of potential projection methodologies exist, including cell-based methodologies, store matrix methodologies, iterative proportional fitting methodologies, virtual census methodologies, and others. The methodologies can be used to generate projection factors. As to any given projection, there is typically a tradeoff among various statistical quality measurements associated with that type of projection. Some projections are more accurate than others, while some are more consistent, have less spillage, are more closely calibrated, or have other attributes that make them relatively more or less desirable depending on how the output of the projection is likely to be used. In embodiments of the platform 100, the projection facility 178 takes dimension information from the MDMH 150 or from another source and provides a set of projection weightings along the applicable dimensions, typically reflected in a matrix of projection weights, which can be applied at the data mart facility 114 to a partial data set in order to render a projected data set. The projection facility 178 may have an interface 182 of any of the types disclosed herein.

In certain preferred embodiments the projection facility 178 may be used, among other things, to select and/or execute more than one analytic technique, or a combination of analytic techniques, including, without limitation, a store matrix technique, iterative proportional fitting (IPF), and a virtual census technique within a unified analytic framework. An analytic method using more than one technique allows the flexible rendering of projections that take advantage of the strengths of each of the techniques, as desired in view of the particular context of a particular projection. In embodiments the projection facility may be used to project the performance of sales in a certain geography. The geography may have holes or areas where no data exists; however, the projection facility may be adapted to select the best projection methodology and it may then make a projection including the unmeasured geography. The projection facility may include a user interface that permits the loading of projection assessment criteria. For example, a user may need the projection to meet certain criteria (e.g. meet certain accuracy levels) and the user may load the criteria into the projection facility. In embodiments the projection facility 178 may assess one or more user-defined criteria in order to identify one or more projections that potentially satisfy the criteria. These candidate projections (which consist of various potential weightings in a projection matrix), can be presented to a user along with information about the statistical properties of the candidate weightings, such as relating to accuracy, consistency, reliability and the like, thereby enabling a user to select a set of projection weightings that satisfy the user's criteria as to those statistical properties or that provide a user-optimized projection based on those statistical properties. Each weighting of the projection matrix thus reflects either a weighting that would be obtained using a known methodology or a weighting that represents a combination or fusion of known methodologies. In some cases there may be situations where no projection can be made that meets the user-defined criteria, and the projections facility may respond accordingly, such as to prompt the user to consider relaxing one or more criteria in an effort to find an acceptable set of weightings for the projection matrix. There may be other times were the projections facility makes its best projection given the data set, including the lack of data from certain parts of the desired geography.

In embodiments, the projection facility 178 may utilize the store matrix analytic methodology. The store matrix methodology is an empirical method designed to compensate for sample deficiency in order to most efficiently estimate the sales for population stores based on data from a set of sample stores. The store matrix methodology is an example of an algorithm that is flexible and general. It will automatically tend to offset any imbalances in the sample, provided that the appropriate store characteristics on which to base the concept of similarity are selected. The store matrix methodology allows projection to any store population chosen, unrestricted by geography or outlet. It is a general approach, and may allow use of the same basic projection methodology for all outlets, albeit potentially with different parameters. The store matrix methodology views projection in terms of a large matrix. Each row of the matrix represents a population store and each column of the matrix represents a census/sample store. The goal of this algorithm is to properly assign each population store's ACV to the census/sample stores that are most similar.

In embodiments, the projection facility 178 may utilize the iterative proportional fitting (IPF) analytic methodology. IPF is designed for, among other things, adjustment of frequencies in contingency tables. Later, it was applied to several problems in different domains but has been particularly useful in census and sample-related analysis, to provide updated population statistics and to estimate individual-level attribute characteristics. The basic problem with contingency tables is that full data are rarely, if ever, available. The accessible data are often collected at marginal level only. One must then attempt to reconstruct, as far as possible, the entire table from the available marginals. IPF is a mathematical scaling procedure originally developed to combine the information from two or more datasets. It is a well-established technique with theoretical and practical considerations behind the method. IPF can be used to ensure that a two-dimension table of data is adjusted in the following way: its row and column totals agree with fixed constraining row and column totals obtained from alternative sources. IPF acts as a weighting system whereby the original table values are gradually adjusted through repeated calculations to fit the row and column constraints. During these calculations the figures within the table are alternatively compared with the row and column totals and adjusted proportionately each time, keeping the cross-product ratios constant so that interactions are maintained. As the iterations are potentially never-ending, a convergence statistic is set as a cut-off point when the fit of the datasets is considered close enough. The iterations continue until no value would change by more than the specified amount. Although originally IPF was been developed for a two-dimension approach, it has been generalized to manage n dimensions.

In embodiments, the projection facility 178 may utilize the virtual census analytic methodology. Virtual census is a dual approach of the store matrix algorithm. Store matrix assigns census stores to sample stores based on a similarity criteria, whereas virtual census assigns sample stores to census stores using a similarity criteria too. Thus, virtual census can be seen as an application of a store matrix methodology, giving the opposite direction to the link between sample and non-sample stores. The way non-sample stores are extrapolated is made explicit in the virtual census methodology, whereas the store matrix methodology typically keeps it implicit. The virtual census methodology can be considered as a methodology solving missing data problems; however, the projection may be considered an imputation system (i.e. one more way to fill in the missing data). The application of this method foresees a computation of “virtual stores.”

In embodiments, the projection facility 178 may use a combination of analytic methodologies. In an example, there may be a tradeoff in using different methodologies among accuracy, consistency and flexibility. For example, the IPF methodology may be highly accurate and highly consistent, but it is not as flexible as other methodologies. The store matrix methodology is more flexible, but less accurate and less consistent than the other methodologies. The virtual census methodology is consistent and flexible, but not as accurate. Accordingly, it is contemplated that a more general methodology allows a user, enabled by the platform, to select among methodologies, according to the user's relative need for consistency, accuracy and flexibility in the context of a particular projection. In one case flexibility may be desired, while in another accuracy may be more highly valued. Aspects of more than one methodology may be drawn upon in order to provide a desired degree of consistency, accuracy and flexibility, within the constraints of the tradeoffs among the three. In embodiments, the projection facility 178 may use another style of analytic methodology to make its projection calculations.

Projection methodologies may be employed to produce projected data from a known data set. The projected data may be associated with a confidence level, a variance, and the like. The projection facility 178 may provide, emulate, blend, approximate, or otherwise produce results that are associated with projection methodologies. Throughout this disclosure and elsewhere, the projection facility 178 may be described with respect to particular projection methodologies, such as and without limitation Iterative Proportional Fitting, Store Matrix, Virtual Census, and so on. It will appreciated that, in embodiments, the projection facility 178 may not be limited to these projection methodologies.

Iterative Proportional Fitting (IPF) was originally designed by Deming and Stephan (1940) for adjustment of frequencies in contingency tables. IPF has been applied to several problems in different domains but is particularly useful in census and sample-related analysis, to provide updated population statistics and to estimate individual-level attribute characteristics.

An issue with contingency tables may be that full data is rarely, if ever, available. The accessible data are often collected at marginal level only and then the entire table may be completed from the available marginal information.

IPF is a mathematical scaling procedure. IPF can be used to ensure that a two-dimension table of data is adjusted so that its row and column totals agree with a fixed constraining row and column totals obtained from alternative sources.

IPF may act as a weighting system, whereby the original table values are gradually adjusted through repeated calculations to fit the row and column constraints. During the calculations, the figures within the table may be alternatively compared with the row and column totals and adjusted proportionately each time, keeping the cross-product ratios constant so that interactions are maintained. As the iterations may be executed continuously, a “Convergence Statistic” may be set as a cut-off point when the fit of the datasets is considered substantially the same. The iterations continue until no value would change by more than the specified amount. IPF has been generalized to manage n dimensions of datasets.

IPF may be better understood by using an algorithm considering a simple two-dimension table.

TABLE 1

| | k = 1 | k = 2 | . . . | k = K | |
|---|---|---|---|---|---|
| h = 1 | | | | | ACV_{1•}^{s} |
| h = 2 | | | | | ACV_{2•}^{s} |
| . . . | | | ACVₕₖ^{s} | | |
| h = H | | | | | ACV_{H•}^{s} |
| | ACV_{•1}^{s} | ACV_{•2}^{s} | | ACV_{•K}^{s} | |

We can define:
pfₕₖⁱ Projection Factor of the cell (h, k) computed at iteration i. pfₕₖⁱ=(ACVₕₖ/ACVₕₖ^{s})
ACVₕₖ Total All Commodity Value (hereafter ACV) of the universe computed at cell (h, k) level.
ACV_{h•} Total ACV of the universe computed at marginal level for row h.
ACV_{•k} Total ACV of the universe computed at marginal level for column k.
ACVₕₖ^{s} Total ACV of the sample computed at cell (h, k) level.
ACV_{h•}^{s} Total ACV of the sample computed at marginal level for row h.
ACV_{•k}^{s} Total ACV of the sample computed at marginal level for column k.
h=1, . . . , H Number of levels of the 1^{st} stratification variable h.
k=1, . . . , K Number of levels of the 2^{nd} stratification variable k.

The following two equations can now be defined:

$$\begin{matrix}{pf}_{hk}^{i} = {pf}_{hk}^{( i - 1 )} \cdot \frac{{ACV}_{h} .}{{\sum }_{k = 1}^{K} {pf}_{hk}^{( i - 1 )} \cdot {ACV}_{hk}^{s}} & ( 1 ) \\ {pf}_{hk}^{( i + 1 )} = {pf}_{hk}^{i} \cdot \frac{{ACV}_{. k}}{{\sum }_{h = 1}^{H} {pf}_{hk}^{i} \cdot {ACV}_{hk}^{s}} & ( 2 )\end{matrix}$$

ACV_{h•} and ACV_{•k} are the pre-defined row totals and column totals respectively.

In an embodiment, equation (1) may be used to balance rows, while equation (2) may be used to balance columns. In terms of probabilities, IPF updates may be interpreted as retaining the old conditional probabilities while replacing the old marginal probability with the observed marginal.

In an embodiment, equations (1) and (2) may be employed iteratively to estimate new projection factors and may theoretically stop at iteration m where:

$${AVC}_{h \cdot } = {\sum }_{k = 1}^{K} {pf}_{hk}^{m} \cdot {ACV}_{hk}^{s}$$

$$and$$

$${ACV}_{\cdot k} = {\sum }_{h = 1}^{H} {pf}_{hk}^{m} \cdot {ACV}_{hk}^{s} .$$

In an embodiment, convergence may be taken to have occurred and the procedure stopped when no cell value would change in the next iteration by more than a pre-defined amount that obtains the desired accuracy. In an embodiment, convergence of the data may not occur if there are zero cells in the marginal constraints, negative numbers in any of the data, a mismatch in the totals of the row and column constraints, or the like.

In an embodiment, empirical evidence may show that a certain percentage of zero cells in the initial matrix may prevent convergence through a persistence of zeros. In an embodiment, a certain percentage of zero cells is undefined but if a matrix contains evenly distributed zeros in more than 30% of the cells or are grouped closely together and comprise around 10% of the table, convergence may not occur.

In an embodiment, IPF may be used when different variables need to be reported and balanced at the same time such as chains, regions, store formats and the like, and the elementary cells obtained by combining all the levels are not well populated. In an embodiment, IPF may allow the set up of constraints at store level (i.e. constraints in the value of projection factors). It may be understood, that when increasing the constraints, the total degrees of freedom may decrease, affecting the number of iterations needed to reach convergence.

In an embodiment, using IPF, the delivered geographies (custom and standard specific) may be balanced. In an embodiment, a geography may be balanced when the total ACV projected from the sample is equal to the total ACV estimated in the universe. A non-balanced geography may be defined as floating.

In an embodiment, if there is a certain percentage of zero cells, there may be a need to develop virtual stores before applying IPF. In an embodiment, if a large number of virtual stores are developed, the projection may no longer fit a very good statistical model.

In an embodiment, once the convergence is reached, the final projection factors pfₕₖ^{m} may be the closest to the initial ones if considering the “Kullback Leibler” distance as a metric. In an embodiment, the table of data that comes out from the application of IPF may be a joint probability distribution of maximum likelihood estimates obtained when the probabilities are convergent within an acceptable pre-defined limit.

In an embodiment, maximum likelihood estimations may provide a consistent approach to parameter estimation problems. This may mean that they can be developed for a large variety of estimation situations.

In an embodiment, maximum likelihood estimations may have desirable mathematical and optimality properties. In an embodiment, they may become minimum variance unbiased estimators as the sample size increases. Unbiased may mean that if large random samples with replacement from a population, the average value of the parameter estimates may be theoretically equal to the population value. By minimum variance (asymptotically efficiency), if there is a minimum variance bound estimator, this method may produce it. In an embodiment, the estimator may have the smallest variance, and thus the narrowest confidence interval of all estimators of that type.

In an embodiment, maximum likelihood estimations may have approximate normal distributions (asymptotic normality) and approximate sample variances that can be used to generate confidence bounds and hypothesis tests for the parameters.

In an embodiment, maximum likelihood estimations may be invariant under functional transformations.

In an embodiment, maximum likelihood estimations may be consistent, for large samples they may converge in probability to the parameters that they estimate.

In an embodiment, maximum likelihood estimations may be best linear unbiased estimations.

In an embodiment, a store matrix may be an empirical method designed to compensate for sample deficiency and most efficiently estimate the sales for a population of stores based on data from a set of sample stores. In an embodiment, the algorithm may be flexible and very general. In an embodiment, the store matrix may automatically tend to offset any imbalances in the sample, provided that we select the appropriate store characteristics on which to base the concept of similarity. In an embodiment, the store matrix may allow the projection of any store population chosen, unrestricted by geography or outlet.

In an embodiment, the store matrix algorithm may view projection in terms of a large matrix. Each row of the matrix may represent a population store and each column of the matrix may represent a census/sample store. The goal of this algorithm may be to properly assign each population store's ACV to the census/sample stores that are most similar.

The table below shows an example of how the matrix looks before any calculations are done.

| | | | | CENSUS/SAMPLE STORES | | | | | | | | | |
|---|---|---|---|---|---|---|---|---|---|---|---|---|---|
| | | | | Marsha's | | Jan's | | | | | | | |
| | | | Store # | 102 | 106 | 201 | 202 | 203 | 204 | 205 | 206 | 207 | 208 |
| | Retailer | Store # | ACV | 16 | 9 | 24 | 18 | 29 | 18 | 12 | 18 | 15 | 26 |
| POPULATION | Marsha's | 101 | 12 | | | | | | | | | | |
| | Marsha's | 102 | 16 | | | | | | | | | | |
| | Marsha's | 103 | 13 | | | | | | | | | | |
| | Marsha's | 104 | 11 | | | | | | | | | | |
| | Marsha's | 105 | 8 | | | | | | | | | | |
| | Marsha's | 106 | 9 | | | | | | | | | | |
| | Marsha's | 107 | 16 | | | | | | | | | | |
| | Marsha's | 108 | 15 | | | | | | | | | | |
| | Marsha's | 109 | 13 | | | | | | | | | | |
| | Marsha's | 110 | 7 | | | | | | | | | | |
| | Jan's | 201 | 24 | | | | | | | | | | |
| | Jan's | 202 | 18 | | | | | | | | | | |
| | Jan's | 203 | 29 | | | | | | | | | | |
| | Jan's | 204 | 18 | | | | | | | | | | |
| | Jan's | 205 | 12 | | | | | | | | | | |
| | Jan's | 206 | 18 | | | | | | | | | | |
| | Jan's | 207 | 15 | | | | | | | | | | |
| | Jan's | 208 | 26 | | | | | | | | | | |
| | Cindy's | 301 | 14 | | | | | | | | | | |
| | Cindy's | 302 | 12 | | | | | | | | | | |
| | Cindy's | 303 | 11 | | | | | | | | | | |
| | Cindy's | 304 | 7 | | | | | | | | | | |
| | Cindy's | 305 | 7 | | | | | | | | | | |
| | Cindy's | 306 | 13 | | | | | | | | | | |
| | Cindy's | 307 | 6 | | | | | | | | | | |
| | Cindy's | 308 | 6 | | | | | | | | | | |
| | Cindy's | 309 | 12 | | | | | | | | | | |

The Store Matrix algorithm/process can be divided into 8 key steps:

a) Calculation of Store Similarity

b) Maximum ACV Calculation (Market Run)

c) ACV Allocation Within Market

d) Minimum ACV Calculation (Region Run only)

e) Initialize calculated ACV (Region Run only)

f) ACV Allocation within Region

g) ACV Re-Allocation

h) Weights Calculation

In an embodiment, virtual census (VC) may be the dual approach of the Store Matrix Algorithm. In an embodiment, the store matrix may assign census stores to sample stores based on a similarity criteria, whereas virtual census may assign sample stores to census stores using a similarity criteria. Therefore, virtual census may be an application of store matrix, providing the opposite direction to the link between sample and non-sample stores. In an embodiment, the way non-sample stores are extrapolated may be made explicit, whereas store matrix may be implicit.

In an embodiment virtual census may create a virtual layer of non sample stores, assigning sample store(s) to each virtual store. In an embodiment, for each virtual store, virtual census may give a list of nearest sample stores, along with projection factors, that may allow building up the ACV (or any measure of size) of the non-sample store represented by the virtual store. Each virtual store may be estimated by a linear combination of sample stores.

Virtual store may be better understood by an example. In the example, there is a universe of 15 stores, among which 5 stores are part of the sample.

The matrix in table 1 shows how each non-sample store (in rows) may be replaced by one virtual store estimated by a linear combination of sample stores (on columns). For example, the sales of store #6 are estimated as 0.2*sales of store #3+0.7*sales of store #4+0.3*sales of store #8. For each non-sample store, only the “nearest” sample stores are used for the calculation.

TABLE 1

| | | | Store | Store | Store | Store | Store |
|---|---|---|---|---|---|---|---|
| Sample | Universe | geography | #3 | #4 | #8 | #11 | #13 |
| | Store #1 | G1 | 0.3 | 0.3 | 0.4 | | |
| | Store #2 | G1 | 0.5 | 0.5 | 0.2 | | |
| X | Store #3 | G1 | 1 | | | | |
| X | Store #4 | G1 | | 1 | | | |
| | Store #5 | G1 | 0.1 | 0.8 | 0.2 | | |
| | Store #6 | G1 | 0.2 | 0.7 | 0.3 | | |
| | Store #7 | G1 | | 0.2 | 0.8 | 0.2 | |
| x | Store #8 | G1 | | | 1 | | |
| | Store #9 | G2 | | | 0.9 | 0.1 | |
| | Store #10 | G2 | | | 0.2 | 0.7 | 0.1 |
| x | Store #11 | G2 | | | | 1 | |
| | Store #12 | G2 | | | | 0.5 | 0.5 |
| x | Store #13 | G2 | | | | | 1 |
| | Store #14 | G2 | | | | 0.5 | 0.6 |
| | Store #15 | G2 | | | | 0.5 | 0.7 |

The distance used to determine the nearest neighbors of a non-sample store may allow taking into account, constraints like region, chain, and store-type. As a result, one can deliver any geography, under releasability conditions, by just giving the list of stores belonging to the geography.

| | | | Store | Store | Store | Store | Store |
|---|---|---|---|---|---|---|---|
| Sample | Universe | geography | #3 | #4 | #8 | #11 | #13 |
| | Store #1 | G1 | 0.3 | 0.3 | 0.4 | | |
| | Store #2 | G1 | 0.5 | 0.5 | 0.2 | | |
| x | Store #3 | G1 | 1 | | | | |
| x | Store #4 | G1 | | 1 | | | |
| | Store #5 | G1 | 0.1 | 0.8 | 0.2 | | |
| | Store #6 | G1 | 0.3 | 0.7 | 0.3 | | |
| | Store #7 | G1 | | 0.2 | 0.8 | 0.2 | |
| x | Store #8 | G1 | | | 1 | | |
| | | | 2.2 | 3.5 | 2.9 | 0.2 | |

For example, the geography G1 may be estimated using 2.2*sales of store #3+3.5*sales of store #4+2.9*sales of store #8+0.2*sales of store #11. Geographies to be released can then be defined by picking stores or by rules as (take all stores in region north from chain A).

In an embodiment, the steps of the system may be:
1. Compute similarities between census and sample store
2. For each census store select the K nearest sample stores (neighbors). K can vary census store—by census store. Sample stores that are outliers are not selected as possible neighbors.
3. For each census store, compute the linear combination to apply to its neighbors, based on the Measure of Size and the similarity.
4. Keep the results of step 3 in a repository projection file, not directly used in production.
5. Create production projection files aggregating stores from the repository projection.

The projection facility 178 may be used in association with a hierarchical modular system that may include cell-based functionality, simplified basic store matrix functionality, calibration, or the like. In an embodiment, the cell-based functionality may allow detailed or macro stratification and relative projection calculation used to support existing cell-based services. In an embodiment, simplified basic store matrix functionality may support the store matrix methodology and virtual census methodology. In an embodiment, calibration may support IPF methodology and its extension (Calibration). In an embodiment, the three different solutions may be used individually or in combination, supporting a very large spectrum of actual and future applications

In a solution A, a (Small) Sample based profile may most commonly be applied to non-enumerated or partially enumerated universes. It may be based on classical and robust sample design. Calibration (IPF) may be used as a way to release a limited set of additional geographies.

In a solution B, a (Large) Sample based profile may most commonly apply to fully enumerated universes. This family of solutions may be outside the classical statistical approach. Sample design may be considered beneficial, but not a key element to guarantee quality: the key element in this case may be the “distance metrics” between Universe and Sample. The store matrix may be useful tools to control universes and the set of geographies in which we need to partition it. Calibration (IPF), if added on, may be a useful tool to add flexibility in creating additional geographies not directly covered by the “distance metrics” function. The resulting quality for these geographies (or the entire set of geographies) could be relatively questionable (not easily predictable or controllable).

In a Solution C, a (Large) Sample based profile may most commonly be applied to fully enumerated universes. This family of solutions can be inside the classical statistical approach in case of trivial applications (Cell Based Only; Cell Based plus basic IPF). A sample design may be considered a key element as well as the calibration methodology. The store matrix can be considered a useful tool to improve quality and/or sample management, but not as a key factor. Calibration (IPF) may allow Universe control together with a relatively flexible way to release several geographies.

In an embodiment, the projection facility 178 may provide a number of capabilities such as:
Support cell-based and marginal-based projection. Capability of supporting multiple projection methods (standard—Ratio/Lacing/Bolt on—IPF).
Support projection to a fully enumerated universe (i.e. a store-level listing of the universe), a partially enumerated universe (i.e. a store-level listing for a portion of the universe with segment/sub-segment estimates of the non-enumerated portion of universe), a non-enumerated universe where only segment/sub-segment estimates of the universe are known, or the like.
Support projection by any reasonable measure of size (MOS), including but not limited to All Commodity Volume, Category Volume, and Store Count.
Allow creation of Secondary level MOS starting from primary one. Example: from MOS=Surface, derive MOS2=log(Surface)
Facilitate new projection set up through a user interface that guides analysts or users through the parameterization of the projection framework.
Facilitate automated production with little-to-no manual intervention.
Enable process monitoring and quality control with alert capabilities when monitoring metrics breach acceptable levels.
Support both approximate and exact projections (detailed documents to be provided).
Facilitate population with either a store-based projection or a household-based (incl. individual/user) projection.
Interact with other processes such as data load and quality control, universe definition/update, sample selection and maintenance, measure-of-size estimation, projection, release evaluation, venue grouping definition, validation of releasability of venue groups, venue group reporting, or the like.
The map of the interactions (input received/output released) may be part of the general design and must be shared and approved with the other areas of the analytic platform 100.
Prior to projection creation allow evaluation of inputs (# of sample, etc.) as part of a quality audit. Allow pre-production data simulation. Allow projected data quality control (Raw data early checks—trend simulation based on basket of product hierarchies).
Support functionality for weight capping, where capping can be done at global-, strata-, and/or venue-levels.
Time dimension for projections must be flexible enough to handle not just weekly data, but also daily data.
Ability to recreate projections for specific week ranges in response to quality concerns or data input corruption.

In embodiments, the projection facility 178 may provide a blend of projection methodologies, which may be manually or automatically selected so as to produce projection factors able to satisfy a desired trade-off between accuracy, consistency, and so on. Accuracy or calibration may pertain to a capability that is associated with a level in an information hierarchy. In embodiments, the projection facility 178 may opt for or automatically choose the level in an information hierarchy that produces the best accuracy or calibration. In embodiments, the information hierarchy may pertain to or contain facts that are associated with a market; may contain information that pertains to or encodes dimensions that are associated with a market; and so on. Spillage may refer to a problem caused by sample stores with a partially matching set of characteristics with respect to the characteristics of stores they are used to represent. Reducing spillage may be associated with deterioration of consistency or calibration. In embodiments, the projection facility 178 may automatically control spillage. Consistency may pertain to a relationship between two or more results that are calculated in different ways or from different data, but that are nonetheless expected to be the same or to exhibit a known or anticipated relationship. The degree to which such an equality or relationship is observed may be the degree to which consistency is present. The projection facility 178 may automatically increase, maximize, or achieve a given level of consistency by adjusting its operation, selecting appropriate source data, choosing and applying a blend of projection methodologies, and so on. Flexibility may pertain to the amount of freedom that is available at query time to choose which level of an information hierarchy will be used to perform calculations, with greater flexibility being associated with greater freedom.

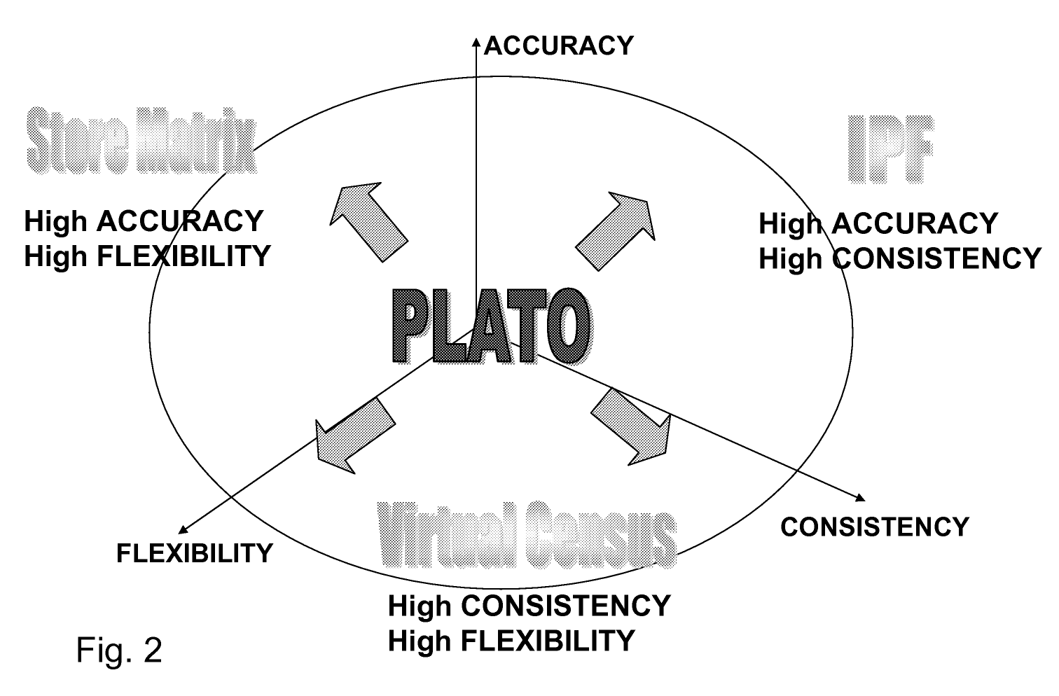

Referring now to FIG. 2, it will be appreciated that different projection methodologies may differ on the three dimensions of accuracy, consistency, and flexibility. For example, IPF may provide relatively good accuracy and consistency, but may be relatively inflexible; store matrix may be relatively flexible and may provide relatively high flexibility, but may provide relatively little consistency (such as may be due to a relatively large amount of spillage or leakage); virtual census may provide relatively high consistency and flexibility, but may provide relatively little accuracy; and so on.

The projection facility 178 may provide a single or unified methodology that includes store matrix, IPF, and virtual census, in addition to a cell-based projection. The methodology may be automatically and/or manually directed to replicate the functionality of its constituent projection methodologies or to provide a blend of the projection methodologies. It will be appreciated that embodiments of the projection facility 178 may provide results of improved precision as new information (or geographies) become available. Embodiments of the projection facility 178 may employ a core information matrix to compute these results.

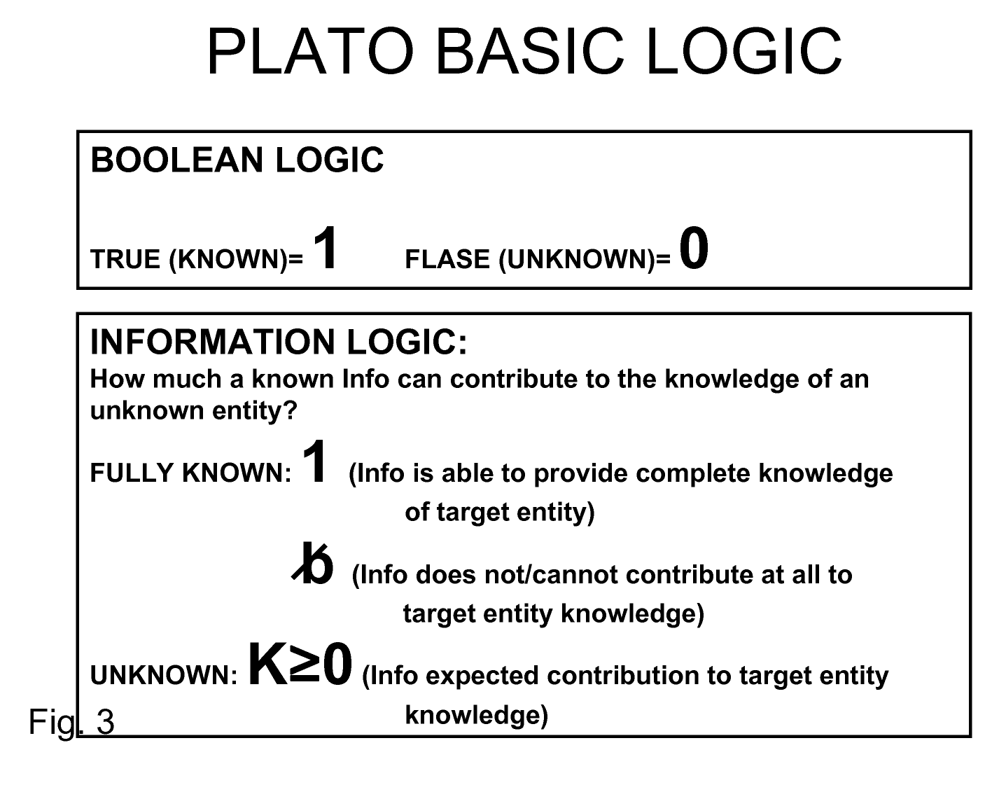

Referring now to FIG. 3, Boolean logic may consist of a 1-state indicating true or known and a 0-state indicating false or unknown. Information logic may consists of a 1-state indicating it is fully known that some information is able to provide complete knowledge of a target entity; a b-slash-state indicating it is fully known that the some information does not or cannot contribute at all to target entity knowledge; and an unknown K-state indicating some information's expected contribution to target entity knowledge, wherein the actual contribution is not fully known.

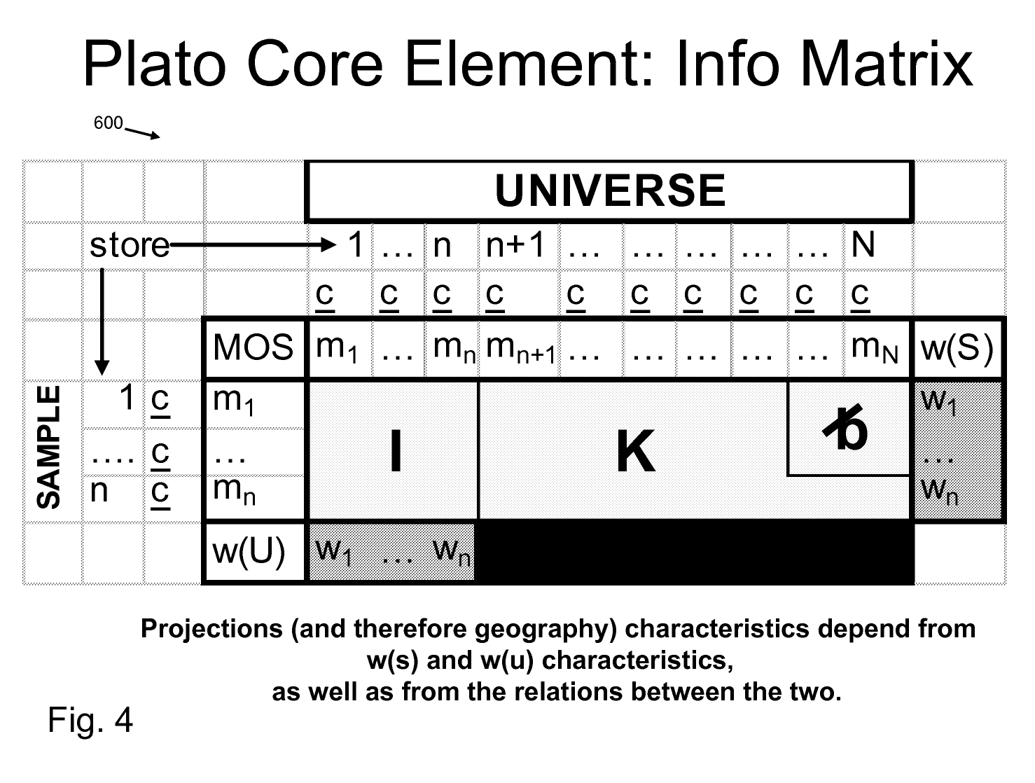

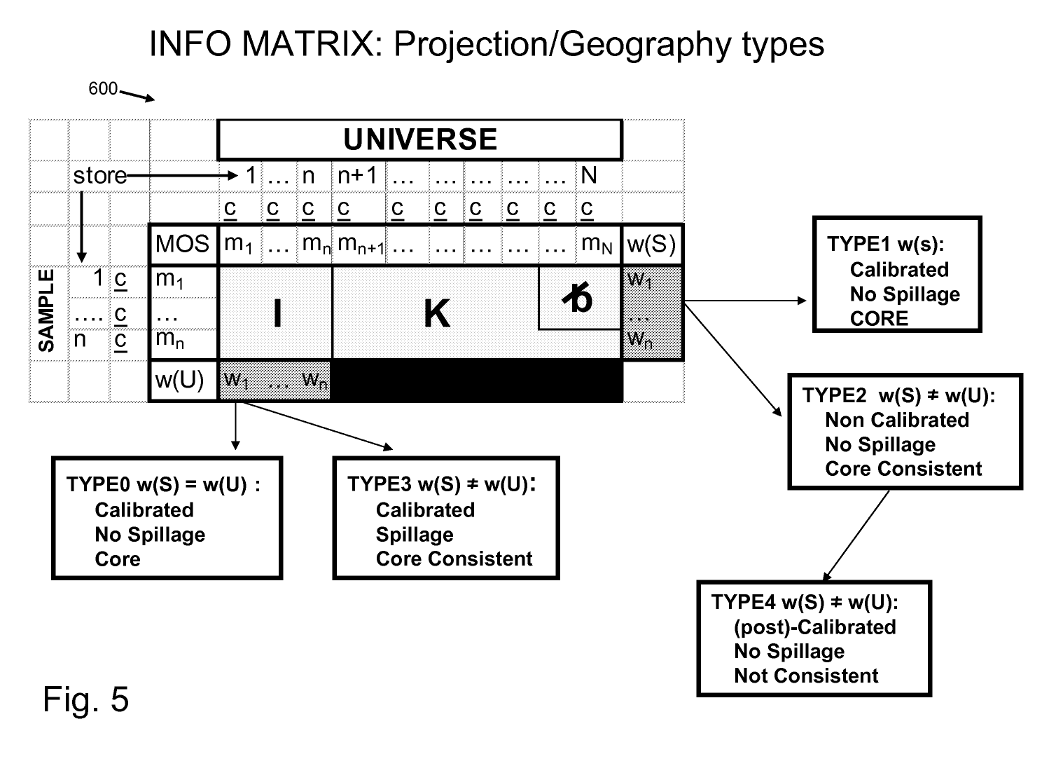

Referring now to FIG. 4, the core information matrix is depicted in two dimensions with a universe of stores 1 through big-N along the horizontal axis and a sample of stores 1 through little-n along the vertical axis. Also along the horizontal axis are measures of size (MOS) m-1 through m-big-N. Also along the vertical axis are measures of size m-1 through m-little-n. In embodiments, the individual measures of size may encompass a universal measure of size divided by the store's measure of size. Also along the horizontal and vertical axes are weights w-1 through w-little-n. As indicated, there are no weights w-n-plus-1 through w-big-n. In other words, only sample stores have weights associated with them. In embodiments, any number of measures of size and any number of weights may be assigned to each cell in the matrix. In other words, each weight w and/or each MOS m may represent an array or hierarchy of weights and measures. These weights and measures may be associated with an array or hierarchy of characteristics of a store. The utility of this will be appreciated especially with reference to FIG. 5, which is described in detail hereinafter and elsewhere. As indicated, the universe of stores includes the samples stores (both contain stores 1 through little-n) although the universe of stores may contain even more stores than that. For the purpose of illustration, the cells of the core information matrix are labeled with information logic states, with a 1-state indicating that a store in the universe is completely known (i.e. the store is in both the sample and the universe), and the K-state and b-slash state respectively indicating that a store in the universe is either known to some expected degree or not known at all. Projections may be calculated with reference to the core information matrix and characteristics of those projections may depend upon w(s) and w (u) characteristics—when w(s) and w(u) are known, then the projection is fully known. In embodiments, the sample stores may all be members of a given geography and the projections may be used to generate additional geographies by imputing or projecting virtual stores. In embodiments, the virtual stores may form the basis of a virtual census. In embodiments, the core information matrix may be populated according to IPF, linear programming techniques, or the like. It will be appreciated that once the core information matrix is populated, it is possible to pull any selection of stores so long as the location of those stores in the matrix is known.

Referring now to FIG. 5, the core information matrix 600 may be utilized to produce different types of projections or projected geographies. In a Type 0 projection, for each sample store used to compute projections, all the sample characteristics equal the universe characteristics and this is true for each store in the universe. Projections of this type may be core projections, being based on calibrated weights with no spillage.

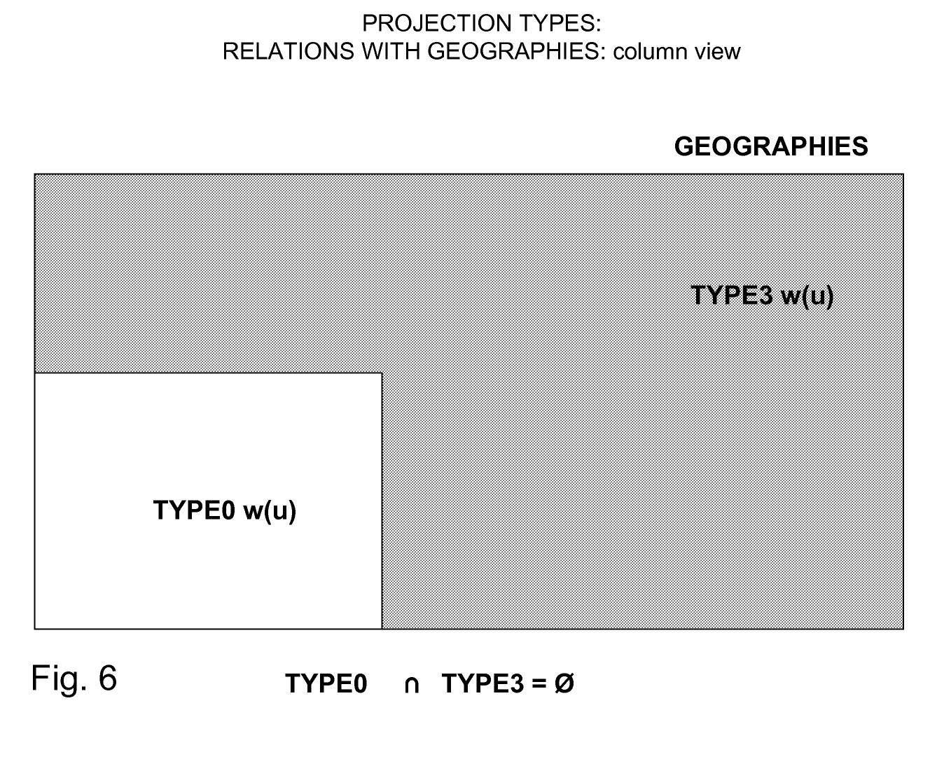

In a Type 3 projection, for at least one store in the projection, the sample characteristics do not equal the universe characteristics. Projections of this type may be consistent with core projections and have the property of being calibrated weights, but may be affected by spillage. It should be appreciated that any chosen projected geography can be one of a Type 0 and Type 3 projection, as depicted in FIG. 6.

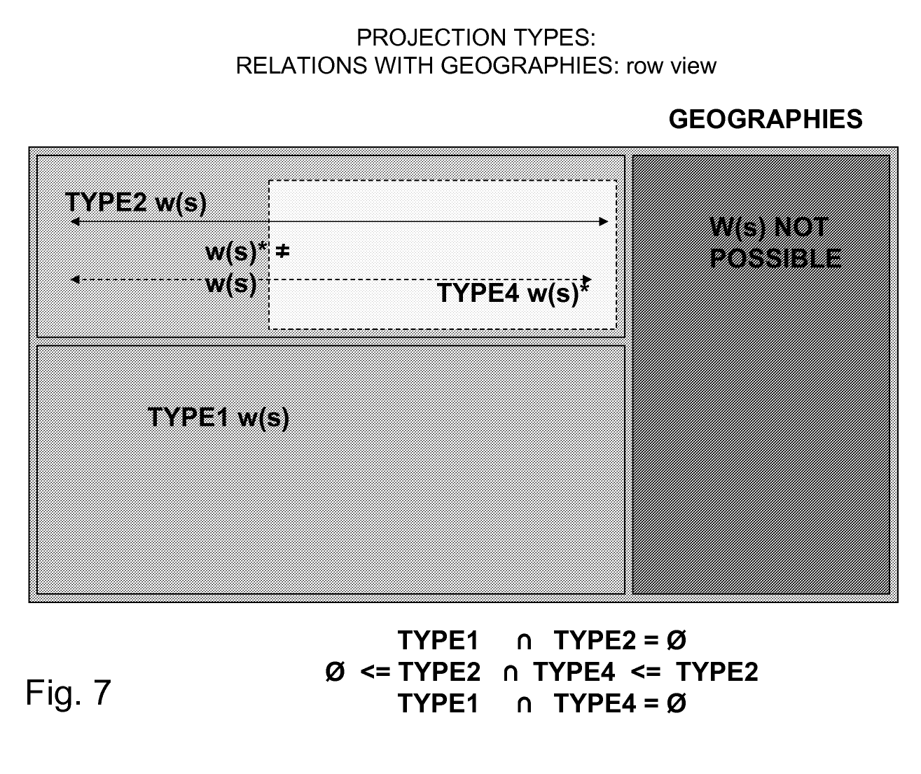

A Type 1 projection is computed as Type 0, but in this case the only requirement may be that sample stores' characteristics are exactly matching the universe characteristics at marginal level (not store by store): they may be a core projection that is characterized by consistency, calibrated weights, and no spillage. As depicted in FIG. 7, it may not always be possible to construct a Type 1 projection in all cases. In practice, row and column weights generally may not be equal or calibrated.

Type 2 projections are computed Type 1 projections used to represent geographies based on characteristics not entirely included in the set of characteristics used to compute type 1 projections. For example and without limitation, suppose that a Type 1 projection represents the Chicago metropolitan area (characteristic used is city=Chicago). If one wanted to partition the Chicago metropolitan area into “North” and “South,” one could compute two Type 1 projections based computation on two characteristics: city=Chicago and location=North; city=Chicago and location=South. Alternatively, one could simply partition the original Type 1 projection of the entire Chicago metropolitan area into North and South partitions. In this case, the partitions are Type 2—they are consistent with the original Type 1 projection (indeed they are of the original Type 1 projection) but the partitions may be not be calibrated and could have spillage. As depicted in FIG. 7, it may not always be possible to construct a Type 2 projection in all cases.

A Type 4 projection may be a Type 2 projection that is post-calibrated. That is, the result of a Type 2 projection may be calibrated to produce a Type 4 projection. By performing this post-calibration step, the Type 2 projection becomes post-calibrated, but consistency is lost.

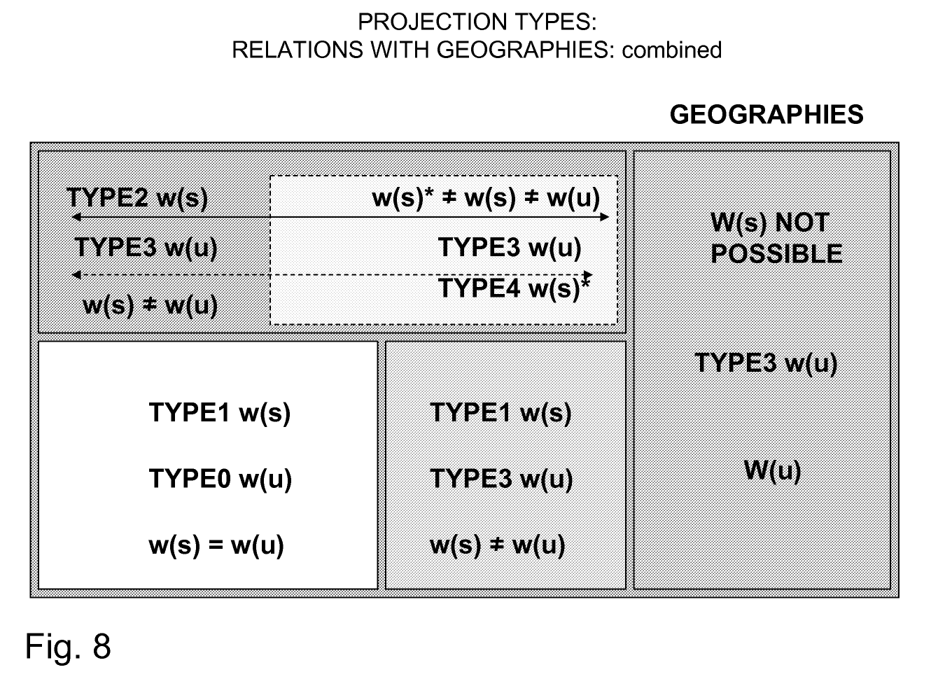

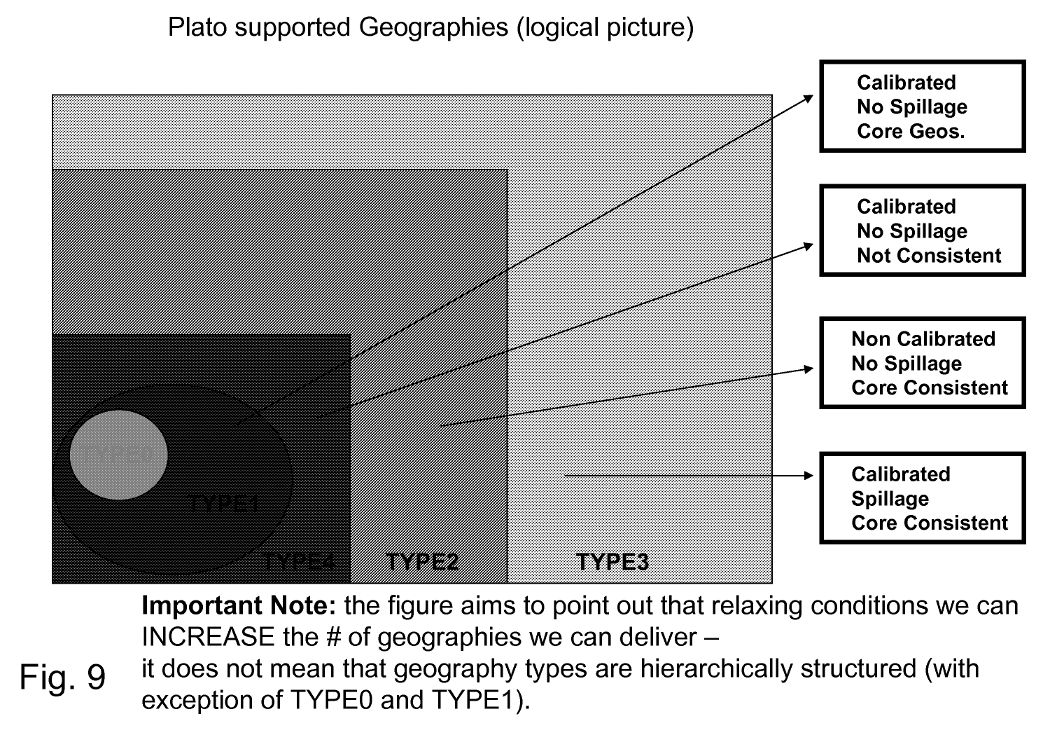

As depicted in FIG. 8, it will be appreciated that the ability to produce Type 0, Type 1, Type 2, Type 3, and Type 4 projections from a single information matrix 600 may allow the projection facility 178 to produce projections weights with a desired mix of calibration/non-calibration, spillage/no spillage, consistency/inconsistency more or less in a automated and on demand way. As a result and as depicted in FIG. 9, tradeoffs between the various projection methodologies may be present and/or chosen and/or blended at run time.

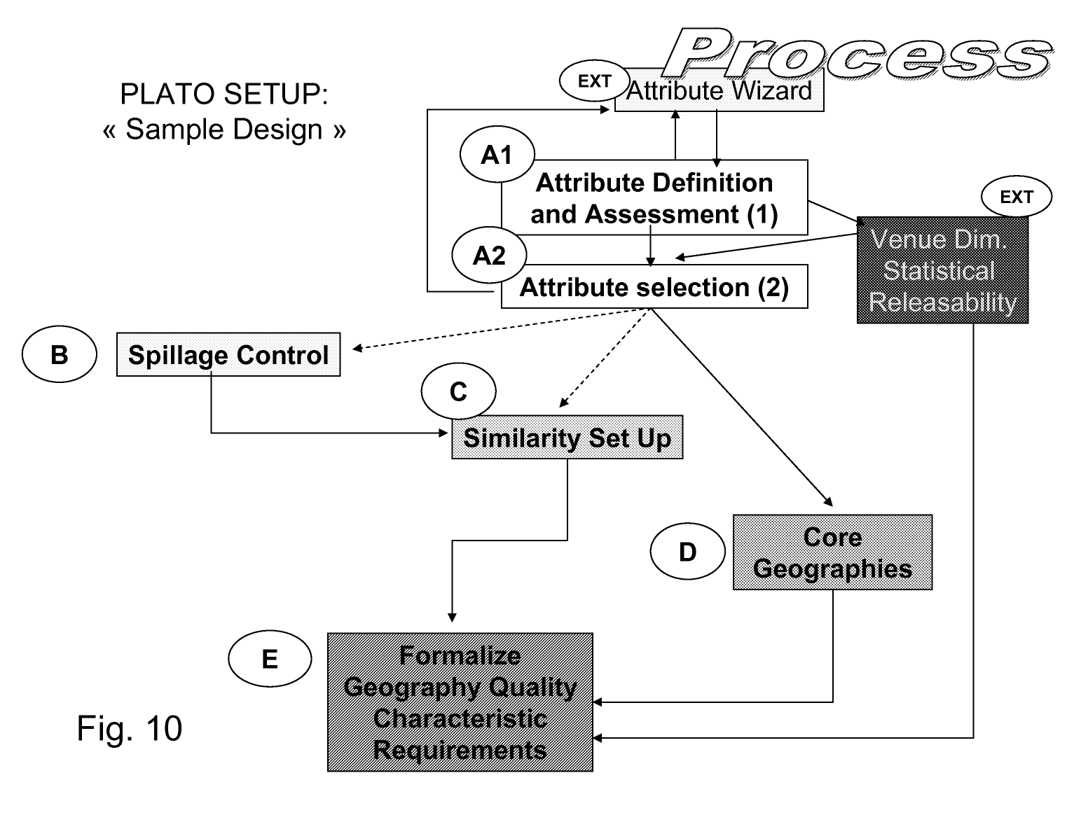

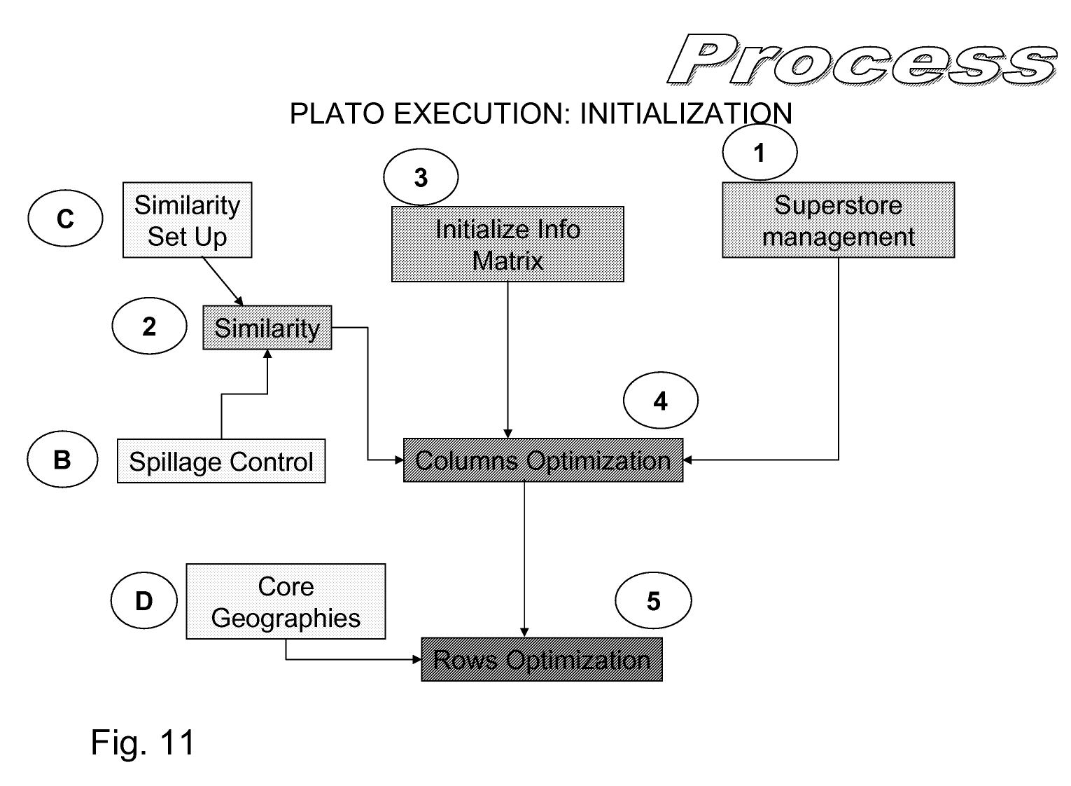

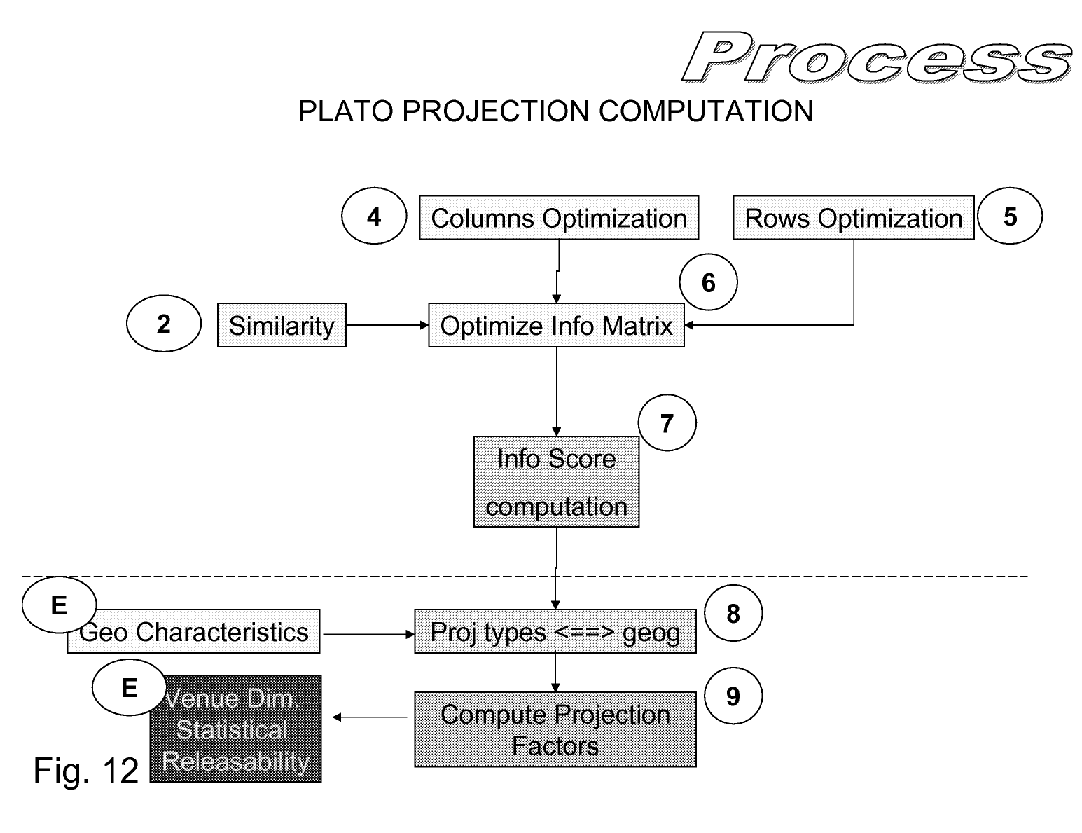

A logical view of the projection facility 178 may comprise three distinct steps. The first step, a set-up step that is described hereinafter with reference to FIG. 10, may comprise activities that are done relatively infrequently. The second step, an initialization step that is described hereinafter with reference to FIG. 11, may comprise activities that are executed more or less periodically, at the start up of a projection session. The third step, an execution step that is described hereinafter with reference to FIG. 12, may comprise activities that compute projections during a projection session. The logical blocks as depicted in FIG. 10, FIG. 11, and FIG. 12 may represent logical steps in a logical flow, logical modules in a logical block diagram of a system or method, and so on. In embodiments, the shaded logical blocks may comprise elements of the projection facility 178 and the grey logical blocks may comprise modules that are external to the projection facility 178.

The process depicted in FIG. 10 may comprise a set of activities that are needed, preferred, or optional in the initialization of a system for generating projections, such as the projection facility 178 in combination with any and all of the elements of the analytic platform 100. Key elements of this process may employ or be associated with a collection of tools for enabling statisticians in one or more of the following: selecting the most appropriate store attributes to be used for reporting purposes (i.e. geography creation) and statistical control (similarity/spillage); identifying the best set of geographies supported by available sample; setting up spillage and similarity quality controls; setting up a geography database inclusive of the list of all geographies to be produced and the statistical quality criteria that these geographies are requested to meet and so on. The process begins with logical block A1, where to-be-projected attributes are defined and assessed. These definitions may be processed by a facility, such as and without limitation the granting matrix 120, to determine whether the projected attributes would be releasable. In any case, processing flow may continue to logical block A2 where some or all of the attributes are selected for projection. Processing flow may then proceed more or less in parallel to logical blocks B, C, and D. Processing at logical block B may be directed at spillage control—that is, limiting or controlling the amount of spillage that will be present in the projection. Processing at logical block C involves setting up similarity measures or other information relating to similarity, which may be described in further detail herein with reference to the similarity facility 180 and elsewhere. Processing at logical block D involves determining, assigning, or otherwise indicating or receiving an indication of one or more core geographies. The results of processing at logical block B are provided to logical block C. The results of processing at logical blocks C and D flow to logical block E, where processing continues so as to formalize quality characteristic requirements for the to-be-projected geographies.

Logical blocks A1 and A2 (attribute assessment/definition/selection) may be associated with a module where, perhaps based upon statistical analysis and/or interaction with subject matter experts, any and all available store attributes are scrutinized and a subset of them are identified as relevant for reporting/statistical purposes. Logical blocks B and C (spillage/similarity control) may be associated with one or more modules with which statisticians may research the best way to control similarity and spillage, perhaps according to a step-by-step process that the modules enable. Elements that control similarity and spillage may be identified through such use of these modules. These elements may be made available to the projection facility 178 for ongoing execution. Logical block D (core geographies) may be associated with a semi-automated module for helping statisticians and subject matter experts in defining which geographies can be eligible to be “CORE” (i.e. calibrated, spillage-free, and consistent with one another). Logical block E may be associated with a geography database including quality specifications. This database may comprise a repository of any and all geographies that need to be produced, together with releasability criteria inclusive of the projection type that is eligible for each geography based on the quality targets.

The process depicted in FIG. 11 may comprise a set of activities that are needed, preferred, or optional in the setup of a system for generating projections, such as the projection facility 178 in combination with any and all of the elements of the analytic platform 100. Key elements of this process may be completely, partially, or not automated and may employ or be associated with: managing superstores, initializing the core information matrix, calculating similarity criteria for a period, column optimization, and row optimization. In embodiments, any and all elements of the analytic platform 100 may be employed to implement the depicted figure. The process may involve similarity calculations at logical block 2, initialization of the core information matrix 600 at logical block 3, and superstore management at logical block 1. The results of processing at logical blocks 1, 2, and 3 flow to logical block 4 where a column optimization procedure is applied to the core information matrix. Then, processing flow continues to logical block 5 where a row optimization procedure is applied to the information matrix.

The superstore management of block 1 may correspond to a system or method for collapsing many (unknown) stores with equal attributes into a single store (i.e. a superstore) having the same attributes. Superstores may be utilized in cases where a store-by-store representation of a universe is incomplete or unknown, but the universe is known at an aggregate level. For example and without limitation, the number of mom-and-pop stores in a geographic region may be known, but individual fact data from each of those stores may be generally unavailable, except perhaps for the stores that are sample stores. Logical block 3 (initialize info matrix) may be associated with populating the core information matrix 600 with relevant (for a given processing period) universe and sample information. Logical block 2 (similarity) may be associated with the similarity facility 180 or any and all other elements of the analytic platform 100 and may provide a base of similarity elements. It will be appreciated that store attributes may change over time and, therefore, similarity criteria may need to be refreshed from time to time, such as and without limitation at each production period. Logical block 4 (columns optimization) may be associated with populating the core information matrix 600 with fresh universe and sample information. Logical block 5 (row optimization) may be associated with computing IPF projected weights for core geographies based on data in the core information matrix.

The process depicted in FIG. 12 may comprise a set of activities that are needed, preferred, or optional to concretely compute projection factors, such as may be computed by the projection facility 178 in combination with any and all of the elements of the analytic platform 100. Key elements of this process may be completely, partially, or not automated and may employ or be associated with: optimizing the core information matrix, computing an information score, geography-projection association, and a projection computation. In embodiments any and all elements of the analytic platform 100 may be employed to implement the depicted figure. Processing flow may begin at logical block 6 where the results of similarity processing, column optimization, and row optimization are brought together in a calculation that optimizes the core information matrix. Processing flow continues to logical block 7, where an information score computation is conducted to produce a set of statistics about the quality of the core information matrix. The statistics may be stored for off-line review. Processing flow then proceeds to logical block 8, where quality characteristic requirements of the to-be-projected geographies are converted, translated, or otherwise applied to determine the projection types that may be used to produce the projections. Processing flow then continues to logical block 9, where projection factors are computed from the core information matrix 600 in accordance with the determined projections.

Logical block 6 (optimize info matrix) may correspond to a system or method for optimizing the core information matrix 600. Initially, the core information matrix 600 may be fed by sample stores that are selected in relation to their similarity/spillage characteristics with respect to the universe of non-sample stores. Row marginal and column marginal, which may be equal to each universe store's measure of size, may encompass constraints that are used to optimize the matrix 600. Logical block 7 (information score computation) may be associated with a system or method for computing a set of statistics about the quality of the core information matrix 600 and storing the statistics off-line for review by, for example and without limitation, a process owner. Logical block 8 (geography-projection association) may be associated with a system or method for identifying which projection factor for a geography provides the best fitting projection for a set of geography-projection quality targets. Logical block 9 (projection computation) may be associated with a system or method for computing a projection based on the type of projection is identified in logical block 8.

As shown in FIG. 1, an interface 182 may be included in the analytic platform 100. In embodiments, data may be transferred to the MDMH 150 of the platform 100 using a user interface 182. The interface 182 may be a web browser operating over the Internet or within an intranet or other network, it may be an analytic engine 134, an application plug-in, or some other user interface that is capable of handling data. The interface 182 may be human readable or may consist of one or more application programming interfaces, or it may include various connectors, adaptors, bridges, services, transformation facilities, extraction facilities, loading facilities, bindings, couplings, or other data integration facilities, including any such facilities described herein or in documents incorporated by reference herein.

As illustrated in FIG. 1, the platform 100 may interact with a variety of applications 184, solutions 188, reporting facilities 190, analytic facilities 192 and services 194, such as web services, or with other platforms or systems of an enterprise or external to an enterprise. Any such applications 184, solutions 188, reporting facilities 190, analytic facilities 192 and services 194 may interact with the platform 100 in a variety of ways, such as providing input to the platform 100 (such as data, metadata, dimension information, models, projections, or the like), taking output from the platform 100 (such as data, metadata, projection information, information about similarities, analytic output, output from calculations, or the like), modifying the platform 100 (including in a feedback or iterative loop), being modified by the platform 100 (again optionally in a feedback or iterative loop), or the like.

In embodiments one or more applications 184 or solutions 188 may interact with the platform 100 via an interface 182. Applications 184 and solutions 188 may include applications and solutions (consisting of a combination of hardware, software and methods, among other components) that relate to planning the sales and marketing activities of an enterprise, decision support applications, financial reporting applications, applications relating to strategic planning, enterprise dashboard applications, supply chain management applications, inventory management and ordering applications, manufacturing applications, customer relationship management applications, information technology applications, applications relating to purchasing, applications relating to pricing, promotion, positioning, placement and products, and a wide range of other applications and solutions.

In embodiments, applications 184 and solutions 188 may include analytic output that is organized around a topic area. For example, the organizing principle of an application 184 or a solution 188 may be a new product introduction. Manufacturers may release thousands of new products each year. It may be useful for an analytic platform 100 to be able to group analysis around the topic area, such as new products, and organize a bundle of analyses and workflows that are presented as an application 184 or solution 188. Applications 184 and solutions 188 may incorporate planning information, forecasting information, “what if?” scenario capability, and other analytic features. Applications 184 and solutions 188 may be associated with web services 194 that enable users within a client's organization to access and work with the applications 184 and solutions 188.

In embodiments, the analytic platform 100 may facilitate delivering information to external applications 184. This may include providing data or analytic results to certain classes of applications 184. For example and without limitation, an application may include enterprise resource planning/backbone applications 184 such as SAP, including those applications 184 focused on Marketing, Sales & Operations Planning and Supply Chain Management. In another example, an application may include business intelligence applications 184, including those applications 184 that may apply data mining techniques. In another example, an application may include customer relationship management applications 184, including customer sales force applications 184. In another example, an application may include specialty applications 184 such as a price or SKU optimization application. The analytic platform 100 may facilitate supply chain efficiency applications 184. For example and without limitation, an application may include supply chain models based on sales out (POS/FSP) rather than sales in (Shipments). In another example, an application may include RFID based supply chain management. In another example, an application may include a retailer co-op to enable partnership with a distributor who may manage collective stock and distribution services. The analytic platform 100 may be applied to industries characterized by large multi-dimensional data structures. This may include industries such as telecommunications, elections and polling, and the like. The analytic platform 100 may be applied to opportunities to vend large amounts of data through a portal with the possibility to deliver highly customized views for individual users with effectively controlled user accessibility rights. This may include collaborative groups such as insurance brokers, real estate agents, and the like. The analytic platform 100 may be applied to applications 184 requiring self monitoring of critical coefficients and parameters. Such applications 184 may rely on constant updating of statistical models, such as financial models, with real-time flows of data and ongoing re-calibration and optimization. The analytic platform 100 may be applied to applications 184 that require breaking apart and recombining geographies and territories at will.

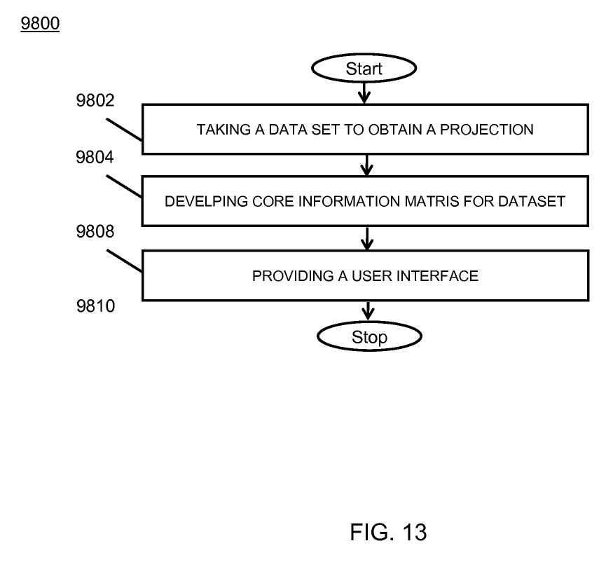

In embodiments, referring to FIG. 13, systems and methods may involve using a platform as disclosed herein for applications described herein where the systems and methods involve taking a dataset from which is desired to obtain a projection 9802. A core information matrix may be developed for data set 9804, where the core information matrix may include regions representing the statistical characteristics of alternative projection techniques that may be applied to the data set. In addition, a user may be provided with an interface 9808 whereby the user may observe the regions of the core information matrix to facilitate selecting an appropriate projection technique.

In embodiments, the statistical characteristics may include goodness of fit, a co-linearity between independent variables used in the data projection, model stability, validity, a standard error of an independent variable, a residual, a user-specified criterion, accuracy, flexibility, consistency, a measure of spillage, a calibration, a similarity statistic, a quality measure, and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method, comprising:
taking a data set from which it is desired to obtain a projection;
developing a core information matrix for data set, the core information matrix including regions representing the statistical characteristics of alternative projection techniques that can be applied to the data set; and
providing a user interface whereby a user can observe the regions of the core information matrix to facilitate selecting an appropriate projection technique.

2. The method of claim 1, wherein the statistical characteristics include goodness of fit.

3. The method of claim 1, wherein the statistical characteristics include a co-linearity between independent variables used in the data projection.

4. The method of claim 1, wherein the statistical characteristics include model stability.

5. The method of claim 1, wherein the statistical characteristics include validity.

6. The method of claim 1, wherein the statistical characteristics include a standard error of an independent variable.

7. The method of claim 1, wherein the statistical characteristics include a residual.

8. The method of claim 1, wherein the statistical characteristics include a user-specified criterion.

9. The method of claim 1, wherein the statistical characteristics include accuracy.

10. The method of claim 1, wherein the statistical characteristics include flexibility.

11. The method of claim 1, wherein the statistical characteristics include consistency.

12. The method of claim 1, wherein the statistical characteristics include a measure of spillage.

13. The method of claim 1, wherein the statistical characteristics include a calibration.

14. The method of claim 1, wherein the statistical characteristics include a similarity statistic.

15. The method of claim 1, wherein the statistical characteristics include a quality measure.
